(19) United States
(12) Patent Application Publication
(10) Pub. No.: US 2005/0239408 A1
(43) Pub. Date: Oct. 27, 2005

(54) Operating method for a terminal in a radio communication system, a radio communication system, terminal and acknowledgement unit for said radio communication system

(76) Inventors: Markus Dillinger, Munchen (DE); Rainer Falk, Poing (DE); Jijun Luo, Munchen (DE); Eiman Bushra Mohyeldin, Munchen (DE)

Correspondence Address: STAAS & HALSEY LLP, SUITE 700, 1201 NEW YORK AVENUE, N.W., WASHINGTON, DC, 20005, US

(21) Appl. No.: 10/525,995

(22) PCT Filed: Jul. 7, 2003
(86) PCT No.: PCT/EP03/07281

§ 371 Date: Feb. 28, 2005

(30) Foreign Application Priority Data
Aug. 30, 2002 (EP) 02019449.4

(51) Int. Cl. H04B 17/00

(52) U.S. Cl. 455/67.11; 455/418

(57) ABSTRACT

A terminal is confirmed to be authorized to operate in a communication system only when it is controlled with respect to the correctness thereof during the operation. Thus, it possible to recognize whether or not the terminal failures perform a negative action on the communication system.

### CROSS REFERENCE TO RELATED APPLICATIONS

This application is based on and hereby claims priority to European Application No. 02019449.4 filed on Aug. 30, 2002, the contents of which are hereby incorporated by reference.

### BACKGROUND OF THE INVENTION

The invention relates to a method for operating a terminal device in a radio communication system, a radio communication system, a terminal device and a confirmation unit for a radio communication system.

In radio communication systems, data transmission from radio stations takes place by way of an air interface. Known radio communication systems are for example wireless local networks (WLAN, Wireless Local Area Network) and also mobile radio systems, for which numerous standards are known. In Europe, first and foremost GSM is known as the standard for the second generation of mobile radio and UMTS as the standard for the third generation of mobile radio. The concept of so-called reconfigurable terminal devices is known in particular in mobile radio systems. These are reconfigured by software downloads executed by way of their air interface. Updating of their operating system can take place, as a result of which for example even a deployment in mobile radio systems is possible, of which the terminal device was not capable prior to the reconfiguration. Since errors can occur during the aforementioned reconfiguration of the terminal devices, errors which affect the operation of the terminal device in such a way as to have a detrimental effect on the overall operation of the radio communication system (by signals being transmitted by an incorrectly reconfigured terminal device in power ranges which are not normally permitted or using formats which are not normally permitted, for example), a method is known whereby a check is performed during operation of such terminal devices on the signals transmitted by them. In this manner it is possible to recognize whether the signals correspond to normal operating conditions. Should this not be the case, the terminal device can be recognized as being defective on account of the errors detected and removed from the radio system.

The method just described has the consequence that negative influences of an incorrectly configured terminal device on the communication system in which it is being operated are only avoided if the check performed on its signals or its functional integrity while it is operating has produced a corresponding negative result.

### SUMMARY OF THE INVENTION

An object of the invention is to reduce the probability of a radio communication system being influenced by incorrectly functioning terminal devices.

A method according to an aspect of the invention for operating a terminal device in a radio communication system provides that the terminal device is only authorized for operation in the radio communication system if a confirmation is present to the effect that the terminal device will be checked for proper functional integrity while it is operating. This allows the terminal device to be deactivated already prior to carrying out the actual check on the functional integrity of the terminal device. For if it is not possible to guarantee a subsequent check of the functional integrity, it is not possible to decide whether the terminal device is functioning correctly or not. Since unrecognized defects in the terminal device can have extremely disadvantageous effects on the radio communication system, its operation is actually prevented where it is determined that the intended check can not be properly carried out.

Advantageously, a method according to an aspect of the invention is implemented immediately during or shortly after commissioning of the terminal device in the communication system. Thus, a negative influence on the radio communication system in the case of a defect in the terminal device is prevented as early as possible. It is however alternatively possible to implement a method according to an aspect of the invention for the first time while the terminal device is actually in operation or also to implement the method repeatedly, periodically for example. In either case a method according to an aspect of the invention has the advantage that negative influences of a defective terminal device on the communication in a radio communication system are not prevented only at the time when a corresponding check of the functional integrity of the terminal device has been performed. This can rather happen as soon as it has been determined that the desired checking of the functional integrity can not be guaranteed. This can be the case for example when a functional problem in the communication system or in the units provided for the checking renders proper checking impossible. However, this can also be the case for example when insufficient resources are available at the current point in time in order to implement the check.

In accordance with a development of the invention, a confirmation signal is provided which, in the event of its being transferred to the terminal device, specifies that the terminal device will be checked while it is operating. With regard to this development, the terminal device is authorized for operation in the communication system by the confirmation signal being sent to the terminal device. In this manner it is possible to advantageously achieve the situation whereby operation of the terminal device is prevented automatically if the confirmation signal is not transferred.

In accordance with a development of the invention, prior to its authorization for operation in the communication system the terminal device sends a request signal to a confirmation unit, whereupon the confirmation unit initiates the checking of the terminal device and sends the confirmation signal to the terminal device. The radio communication system learns of the existence of the terminal device from the request signal and can make available the resources required for checking the functional integrity of the terminal device, which is signaled by the confirmation signal sent by the confirmation unit.

For sending the request signal to the confirmation unit the terminal device advantageously uses an address stored previously in the terminal device, which address is predefined for use by a plurality of terminal devices at least in this communication system. This makes it possible for the request signal from the terminal device to also actually reach the confirmation unit. In this situation the address of the confirmation unit used for this purpose may have been stored in the terminal device either during the actual manufacture of the terminal device or alternatively during a subsequent configuration of the terminal device by a software download. However, it is also possible for the address to have been notified to the terminal device by a broadcast signal from the respective radio communication system. In both the formerly mentioned cases it is advantageous if the address of the confirmation unit is suitable for use in more than one radio communication system. If the terminal device is then able to initiate a communication in this plurality of communication systems, it can request an authorization by way of its request signal for its operation in the communication system already at the time of its commissioning by transmitting the same address in each case without additional knowledge of details of the respective communication system.

In accordance with an advantageous development of the invention, the terminal device only sends the request signal after a predefined period of time has elapsed following a registration performed by the terminal device with the communication network, during which period of time it has not already automatically received the confirmation signal. In this case registration is understood to be a procedure in which the terminal device provides the communication system with a knowledge of its existence. The communication system is then able to confirm automatically to the terminal device the check on the functional integrity of the terminal device that is to be performed subsequently without the request signal needing to have been transmitted previously. Such a procedure is possible particularly in radio communication systems which are operated by a system operator that is responsible for the necessary checking. System operators of this type exist in known mobile radio systems such as GSM for example and in the planned UMTS. There are however no system operators in the radio communication systems with decentralized organization such as WLAN for example or so-called self-organizing systems or ad hoc systems such as Bluetooth for example. If the terminal device is situated in one of the latterly mentioned systems, it will not be able to receive an automatic confirmation signal because of the lack of a central entity which could initiate the necessary check. After the aforementioned period of time has elapsed, such a confirmation signal is no longer expected to arrive (the terminal device can thereupon conclude that it is located in a communication system with no system operator), with the result that the terminal device then sends out its request signal. The latter can, through use of the relevant address of the confirmation unit, also advantageously be forwarded in a network with a decentralized organization specifically to an appropriate service provider that initiates the desired check and sends the confirmation signal to the terminal device.

In accordance with a development of the invention, a plurality of devices are capable of performing checking of the terminal device for proper functional integrity while it is operating. Advantageously, prior to performing the check the method determines which of these devices is performing the checking of the terminal device. It is then possible to flexibly assign the resources of the available devices which basically come into consideration for the check, also in the case of a large number of terminal devices for which the described check is to be performed, to the terminal devices.

Determining which device performs the check is advantageously carried out in such a way that the device is located in closest possible proximity to the terminal device. This achieves the result that signals to be transferred during checking between the terminal device and the device used for performing the check have only relatively short paths to travel, which means that minimal loading is imposed in total on the capacities of the communication system by these additional signals.

Alternatively, the terminal device itself can be defined as the device for performing the check, with software needed for performing the check being delivered to the terminal device by way of an air interface. With regard to this embodiment of the invention, the signals produced by the terminal device are actually checked by the terminal device itself prior to their transmission over the air interface. Using a software download over the air interface, the program can be continuously updated for performing the check and can be adapted to the relevant communication system in which the terminal device is currently located. The aforementioned program can even be selected depending on a current location of the terminal device in the communication system.

In accordance with a development of the invention, during checking of the terminal device, signals to be transferred by the latter are checked for compliance with at least one particular quality criterion whose value is dependent on where the terminal device is situated within the radio communication system. Certain maximum permissible delay times or maximum permissible transmit power values, for example, come into consideration as the quality criterion. As a result of the aforementioned location-dependent differing implementation of the checking of the terminal device, it is possible to advantageously take into consideration the fact that varying degrees of compliance with quality criteria can perfectly well be necessary in one and the same communication system. For example, in areas of a communication system in which a high traffic density is normally the case the requirements concerning the signal quality to be observed or concerning the freedom from errors of the terminal device in question are more demanding than in areas where a low traffic density is normally the case. In the first-mentioned case the influence of strong noise signals is made more serious by a possibly defective terminal device than in the last-mentioned case.

In accordance with a further development of the invention, after authorization of the terminal device for operation, the further operation of the terminal device in the communication system is then only subsequently refused if the check on the terminal device for proper functional integrity during operation has yielded a certain number of errors or an error which exceeds a particular threshold value. This procedure makes it possible to authorize further operation of the terminal device in the situation where although errors are detected they can however still be tolerated with regard to operation of the overall communication system. Only when the number of errors or the severity of the error can no longer be tolerated with regard to operation of the communication system will the terminal device be excluded from further operation.

### BRIEF DESCRIPTION OF THE DRAWINGS

These and other objects and advantages of the present invention will become more apparent and more readily appreciated from the following description of the exemplary embodiments, taken in conjunction with the accompanying drawings of which:

FIG. 1 is a block diagram of a part of a radio communication system according to the invention,

FIG. 2 is a schematic representation of the sequence of the method according to the invention for the radio communication system shown in FIG. 1,

FIG. 3 is a flowchart for implementing a check on a terminal device within the communication system shown in FIG. 1, and

FIG. 4 is a block diagram of the terminal device in the radio communication system shown in FIG. 1.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

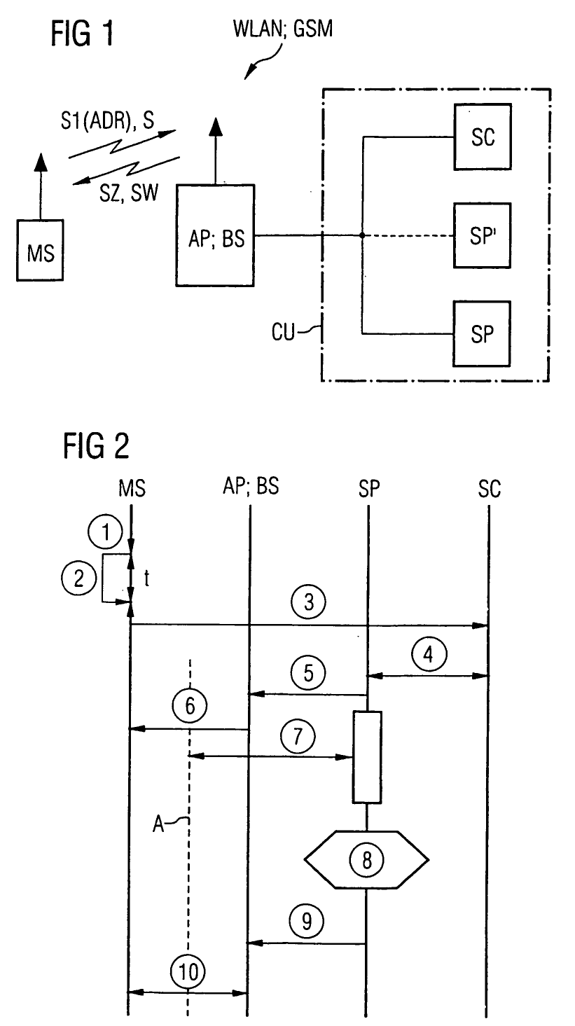

FIG. 1 shows a part of a radio communication system WLAN; GSM. In this radio communication system is situated a terminal device MS taking the form of a mobile user station which can be configured by way of an air interface by transferring corresponding software such that it can be operated in communication systems based on different standards. The communication system can be either a centrally organized system for which a system operator is present, as is the case for example with the GSM system. The communication system WLAN can however also be a non-centrally organized system for which no system or network operator is present, as is the case for example with ad hoc networks. The terminal device MS considered here can be operated in both types of radio systems.

The communication system WLAN; GSM has a network access station AP; BS which in the case of the ad hoc network WLAN is normally referred to as access point AP and in the case of a GSM network as base station BS. The network access station AP; BS is connected to a confirmation unit CU whose function is described in further detail in the following. The confirmation unit CU includes a plurality of geographically separated components SC, SP, SP′. One of these components is a checking center SC. In addition, the confirmation unit CU has two checking devices SP, SP′. The checking center serves to select one of the checking devices in order to implement a check on the terminal device for proper functional integrity. The checking devices SP, SP′ serve to implement a corresponding check on the terminal device MS, provided they have previously been designated for this purpose by the checking center SC. The units SC, SP, SP′ within the confirmation unit CU can be made available by one or more different service providers in each case. If the radio communication system shown in FIG. 1 is a GSM network, the components SC, SP, SP′ of the confirmation unit CU are preferably components of the radio communication system. If the communication system is an ad hoc network or another system without a system operator, at least the checking center SC and preferably also the checking devices SP, SP′ are made available through special service providers which the terminal device MS can access by way of the communication system WLAN.

The checking center SC in FIG. 1 can also determine that the terminal device MS will check its own functional integrity. To this end the checking center SC sends appropriate checking software SW by way of the network access station AP; BS over the air interface to the terminal device MS. The software SW then enables the self-initiating checking of the terminal device MS.

The functional integrity of the radio communication system WLAN; GSM shown in FIG. 1 is described with reference to FIG. 2. In this situation the individual operations are consecutively numbered with the digits 1 to 10 in FIG. 2, to which reference is made in the following. FIG. 2 shows from left to right operations which are executed by the different components of the radio communication network WLAN; GSM shown in FIG. 1. From left to right in FIG. 2 these components are the terminal device MS, the network access station AP; BS, one of the checking devices SP and also the checking center SC. In a first step, a reconfiguration of the terminal device MS is initiated. In a second step, the terminal device MS initially waits for a time period t to determine whether it receives a confirmation signal from the radio communication system WLAN; GSM indicating that the terminal device will be checked for proper functional integrity while it is operating. Such a confirmation signal, which is denoted by S2 in FIG. 1, is however only generated automatically by the communication system if this is one having a system operator, in other words the GSM network GSM in the present case. In such a case, the third step described in the following would be skipped and the method continued immediately with the fourth step. In FIG. 2 it has been assumed however that the terminal device MS is currently situated in the ad hoc network WLAN. Since in this case there is no central system operator, during the time period t the terminal device MS does not receive a confirmation signal S2 from the network access station AP; BS of the radio communication system. In a third step after the time period t has elapsed, the terminal device MS therefore sends a request signal to the checking center SC. The request signal S1 which the terminal device MS sends to the network access station AP; BS is shown in FIG. 1. From there it passes to the checking center SC, whereby the terminal device MS uses an address ADR of the checking center SC, which address has previously been stored in the terminal device MS. In response to the request signal S1, checking center SC determines in a fourth step that the checking device SP is to perform checking of the terminal device MS for proper functional integrity. The checking center SC selects the particular checking device SP which is situated closest to the network access station AP; BS or to the terminal device MS.

In a fifth step, the checking devices SP selected by the checking center SC sends a confirmation signal to the network access station AP; BS which in a sixth step passes on the confirmation signal S2 (cf. FIG. 1) to the terminal device MS. After receiving the confirmation signal S2, the terminal device MS continues its operation.

If the terminal device MS were not to receive a confirmation signal S2 that would amount to the same thing as there having been no authorization for operation issued to the terminal device and the terminal device MS would deactivate itself.

In a seventh step, the air interface A between the terminal device MS and the network access station AP; BS is checked by the checking device SP in respect of correct signals of the terminal device MS. If errored behavior of the terminal device MS is subsequently detected in an eighth step by the checking device SP, this is notified to the network access station AP; BS in a ninth step, whereupon a reconfiguration of the terminal device by a software download takes place in a tenth step in order to recover the error. The ten steps described can then be executed again.

FIG. 4 shows the terminal device MS from FIG. 1. In addition to a transmit device MSTX and a receive device MSRX for transmitting and receiving signals, the terminal device MS includes a processor MSP for controlling its functions. Furthermore, it has a timer T for measuring the time period t as per the second step from FIG. 2. Furthermore, the terminal device MS contains a memory in which the address ADR of the confirmation unit CU or of its checking center SC is stored. In addition, a deactivation unit DA is present which effects the described deactivation of the terminal device MS when either no confirmation signal S2 is received by way of the receive device MSRX or a special deactivation signal is received which is the case in the event of an error in the functional integrity of the terminal device MS detected by checking duration operation.

The checking devices SP, SP′ and also the checking center SC in FIG. 1 have receive devices and transmit devices for receiving and transmitting the corresponding signals, and also have a processor in each case which is used for controlling them.

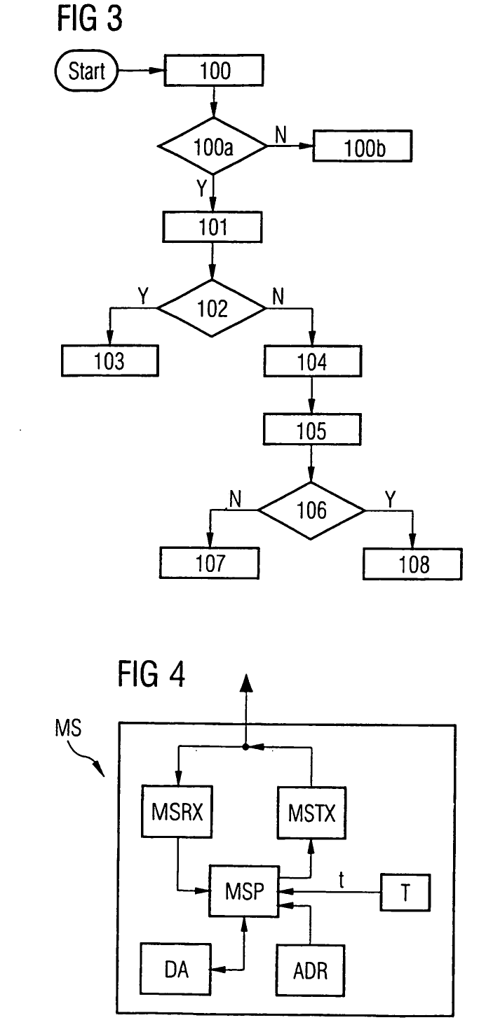

According to FIG. 3, during commissioning of the terminal device MS from FIG. 1 the method for generating the confirmation signal S2, as described according to FIG. 2, is first initiated (block 100). In block 100a a check is performed to determine whether the confirmation signal S2 has been sent to the mobile station MS. If this is not the case, the terminal device MS automatically deactivates itself (block 100b). If this is the case, however, the check of the functional integrity of the terminal device MS is performed while it is operating (block 101). In the event of an error occurring, is check is first made to determine whether the error is recoverable (block 102). The reason why the terminal device MS is not also deactivated immediately in the event of an unrecoverable error is that the requirements relating to freedom from errors of operation of the terminal device MS can change as a result of a possible movement of the terminal device MS in the radio communication system at a later point in time (for example on leaving the current cell of a cellular mobile radio system and entering a new cell).

If the error is recoverable, the error is recovered by appropriate instructions from the checking device SP to the terminal device MS (block 103). This is done by placing the terminal device MS in a corresponding operating state. If the detected error is not recoverable, however, the existing connection of the terminal device MS, over which the signals S are sent in FIG. 1, is interrupted (block 104). A comparison of the current check results from the checking device SP with older measurement results which the checking device SP has already determined previously for the same terminal device MS is then performed (block 105). In this situation, an investigation is carried out as to whether multiple instances of the same error have already occurred and whether in this case a previously defined number of the same error has already been exceeded. Alternatively, instead of the comparison with errors which have already occurred previously it is also possible to check the severity of the error (block 106). The number of permissible errors or the severity of the error which can still just be tolerated depends on where the terminal device MS is currently situated within the communication system WLAN; GSM. The current position can be ascertained for example by way of an appropriate Location Service Provider or by utilizing Mobility Management information. If the terminal device MS is located for example in a private environment (the user's apartment) or in an environment with a generally low traffic volume, the requirements concerning the freedom from errors for operation of the terminal device MS can be less demanding than in areas with high demands on the reliability of operation or having a high traffic volume.

If this interrogation determines that the predefined number of errors has not been exceeded or that the severity of the error still lies within the tolerable range, the terminal device MS remains authorized for further operation and is placed in a standby mode (block 107). However, if the specified error count has been exceeded or if the severity of the error is not longer tolerable, the terminal device MS is deactivated by an appropriate signal from the checking device SP (block 108).

In order to determine errors which occur during operation of the terminal device MS, the checking device SP can check the signals S sent out by the terminal device MS for compliance with protocols which are defined by the standard applying to the respective communication system WLAN; GSM.

The checking center SP shown in FIG. 1 also has the capability to define the terminal device MS itself for performing the check for proper functional integrity instead of the checking device SP, SP′. For this purpose, the checking center SC can download appropriate checking software SW by way of the network access station AP; BS to the terminal device MS. The terminal device MS then utilizes this checking software SW in order to perform its own checking.

The address ADR of the checking center SC used for transmitting the request signal S1 is advantageously valid for all possible communication systems in which the terminal device MS can be operated (for example, after it has been made fit for use by appropriate software downloads for such types of systems in each case). The address ADR can for example be a particular telephone number valid for all communication networks. Such an address ADR would then be comparable with the emergency telephone numbers commonplace today which are standardized in a great diversity of mobile radio systems. In Germany, for example, this emergency number is “112”.

The invention is suitable for use in any desired terminal devices MS which can be reconfigured by software downloads. It is suitable for use in any desired radio communication networks in which such types of reconfigurable terminal devices can be used.

It is also possible that instead of only one checking device SP a plurality of checking devices SP, SP′ and also possibly the terminal device itself MS simultaneously perform checking of the functional integrity of the terminal device MS while it is operating. This is likewise defined by the checking center SC. In this situation, any of the units involved in such a check can monitor or check certain parameters or protocol messages of the terminal device MS assigned to it by the checking center SC.

Apart from being performed under the aspect of minimizing the data traffic in the overall communication network, the selection of the checking device SP performing the check by the checking center SC can also be performed under the aspect of distributing the compute-intensive checking measures evenly between the available checking devices SP, SP′.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. A method for operating a terminal device in a radio communication system, comprising:
authorizing operation of the terminal device in the radio communication system only upon confirmation that the terminal device will be checked for proper functional integrity during operation.

15. The method according to claim 14,
wherein said authorizing operation of the terminal device in the communication system includes sending a confirmation signal to the terminal device, and
wherein said method further comprises responding to receipt of the confirmation signal by the terminal device being checked during operation.

16. The method according to claim 15, further comprising:
sending a request signal from the terminal device to a confirmation unit prior to said authorizing operation of the terminal device in the communication system, and
initiating checking of the terminal device by the confirmation unit in response to the request signal, and
wherein said sending of the confirmation signal to the terminal device is performed by the confirmation unit after said checking.

17. The method according to claim 16,
further comprising previously storing an address of the confirmation unit in the terminal device and in a large number of terminal devices at least in the communication system, and
wherein said sending the request signal to the confirmation unit includes the terminal device using the address of the confirmation unit stored previously in the terminal device.

18. The method according to claim 17,
further comprising registering the terminal device with the communication network, and
wherein said sending of the request signal by the terminal device only occurs after a predefined period of time has elapsed following said registering and the terminal device has not automatically received the confirmation signal.

19. The method according to claim 18, wherein a plurality of devices are capable of performing said checking of the terminal device for proper functional integrity during operation, and
wherein said method further comprises determining, prior to said checking, which of the devices is performing said checking of the terminal device.

20. The method according to claim 19, wherein said determining of which device is performing said checking includes locating one of the devices in closest possible proximity to the terminal device.

21. The method according to claim 20, wherein the terminal device performs said checking, and
wherein said method further comprises delivering software needed for performing said checking to the terminal device via a wireless interface.

22. The method according to claim 21, wherein said checking of the terminal device, includes checking signals to be transferred by the terminal device for compliance with at least one quality criterion having value dependent on where the terminal device is situated within the radio communication system.

23. The method according to claim 22, further comprising refusing operation of the terminal device in the communication system after said authorizing of the terminal device for operation only if said checking of the terminal device has yielded one of a predetermined number of errors and an error exceeding a threshold value.

24. A radio communication system, comprising:
a confirmation unit, including
a signal generation device generating a confirmation signal; and
a transmit device sending the confirmation signal; and
a terminal device, including
a receive device receiving the confirmation signal indicating that said terminal device will be checked for proper functional integrity during operation; and
a deactivation unit only permitting further operation of said terminal device if said receive device has received the confirmation signal.

25. A terminal device for a radio communication system having a confirmation unit, comprising:
a receive device receiving a confirmation signal from the confirmation unit of the communication system, indicating that that said terminal device will be checked for proper functional integrity during operation in the communication system; and
a deactivation device only permitting further operation of said terminal device if said receive device has received the confirmation signal.

26. A confirmation unit for a radio communication system having at least one terminal device, comprising:
a device generating a confirmation signal, from which it can be inferred that the at least one terminal device will be checked for proper functional integrity during operation in the communication system; and
a transmit device sending the confirmation signal to the terminal device.
